(19) United States
(12) Patent Application Publication
(10) Pub. No.: US 2017/0316522 A1
(43) Pub. Date: Nov. 2, 2017

(54) MATCHING SYSTEM, INFORMATION PROCESSING DEVICE, MATCHING METHOD, AND PROGRAM

(71) Applicant: SONY CORPORATION, Tokyo (JP)

(72) Inventors: Sho MURAKOSHI, Tokyo (JP); Yoshihiro NAKANISHI, Tokyo (JP); Hideyuki MATSUNAGA, Kanagawa (JP); Katsuji MIYAZAWA, Tokyo (JP)

(21) Appl. No.: 15/523,402

(22) PCT Filed: Aug. 20, 2015
(86) PCT No.: PCT/JP2015/073446

§ 371 Date: Apr. 30, 2017

(30) Foreign Application Priority Data
Nov. 20, 2014 (JP) 2014-235485

(51) Int. Cl. G06Q 50/10; G06Q 10/06

(52) U.S. Cl. CPC G06Q 50/10; G06Q 10/063114

(57) ABSTRACT

The present disclosure provides a matching system, information processing device, matching method, and program that are capable of introducing a currency requested person to a requester in a real space in real time. The matching system includes: an acquisition unit configured to acquire information on service providers; and a selection unit configured to select a service provider capable of handling a service request by reference to service providable time of the service providers, current positions of the service providers, and characteristics of the service providers that are included in the information on the service providers acquired by the acquisition unit.

### TECHNICAL FIELD

The present disclosure relates to matching systems, information processing devices, matching methods, and programs.

### BACKGROUND ART

In recent years, technologies of information recommendation have been developed, and systems for recommending information convenient for a user on the basis of personal information of the user have been proposed in various kinds of fields.

For example, Patent Literature 1 proposes an information providing system capable of acquiring information beneficial for a user without identifying the user.

### CITATION LIST

### Patent Literature

Patent Literature 1: JP 2004-94320A

### DISCLOSURE OF INVENTION

### Technical Problem

However, the existing technologies that have been proposed are systems for providing information beneficial for users (that is, technologies for linking people and information). A technology for linking people in a real space has not been adequately developed yet.

Accordingly, the present disclosure proposes a matching system, information processing device, matching method, and program that are capable of introducing a currency requested person to a requester in a real space in real time.

### Solution to Problem

According to the present disclosure, there is provided a matching system including: an acquisition unit configured to acquire information on service providers; and a selection unit configured to select a service provider capable of handling a service request by reference to service providable time of the service providers, current positions of the service providers, and characteristics of the service providers that are included in the information on the service providers acquired by the acquisition unit.

According to the present disclosure, there is provided an information processing device including: an acquisition unit configured to acquire information on service providers; and a selection unit configured to select a service provider capable of handling a service request by reference to service providable time of the service providers, current positions of the service providers, and characteristics of the service providers that are included in the information on the service providers acquired by the acquisition unit.

According to the present disclosure, there is provided a matching method including: acquiring information on service providers; and selecting a service provider capable of handling a service request by reference to service providable time of the service providers, current positions of the service providers, and characteristics of the service providers that are included in the acquired information on the service providers.

According to the present disclosure, there is provided a program causing a computer to function as: an acquisition unit configured to acquire information on service providers; and a selection unit configured to select a service provider capable of handling a service request by reference to service providable time of the service providers, current positions of the service providers, and characteristics of the service providers that are included in the information on the service providers acquired by the acquisition unit.

### Advantageous Effects of Invention

As described above, according to the present disclosure, it is possible to introduce a currency requested person to a requester in a real space in real time.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating an overview of a matching system according to an embodiment of the present disclosure.

FIG. 2 is a block diagram illustrating an example of a configuration of a server according to the embodiment.

FIG. 3 is a block diagram illustrating an example of a configuration of a volunteer terminal according to the embodiment.

FIG. 4 is a block diagram illustrating an example of a configuration of a user terminal according to the embodiment.

FIG. 5 is a sequence diagram illustrating an operation process according to a first embodiment.

FIG. 6 is a diagram illustrating an example of a help information input screen according to the embodiment.

FIG. 7 is a diagram illustrating an example of a help display screen for a volunteer according to the embodiment.

FIG. 8 is a flowchart illustrating a process of collecting purchase history data.

FIG. 9 is a flowchart illustrating a process of collecting information on an SNS or a marriage-hunting website.

FIG. 10 is a flowchart illustrating a process of collecting behavior information or content (photographs and videos).

FIG. 11 is a flowchart illustrating a process of inviting a volunteer.

FIG. 12 is a sequence diagram illustrating an operation process according to a second embodiment.

FIG. 13 is a diagram illustrating an example of displaying properties according to the second embodiment.

FIG. 14 is a sequence diagram illustrating another operation process according to the second embodiment.

FIG. 15 is a diagram illustrating another example of displaying properties according to the second embodiment.

FIG. 16 is a sequence diagram illustrating an operation process according to a third embodiment.

FIG. 17 is a diagram illustrating an example of AR display of volunteer information according to the third embodiment.

FIG. 18 is a sequence diagram illustrating an operation process for inputting evaluation according to a fourth embodiment.

FIG. 19 is a flowchart illustrating an operation process of volunteer matching according to the fourth embodiment.

FIG. 20 is a sequence diagram illustrating an operation process of volunteer matching according to a fifth embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that the description is given in the following order.
1. Overview of matching system according to embodiment of present disclosure
2. Basic configuration
2-1. Server
2-2. Volunteer terminal
2-3. User terminal
3. Embodiments
3-1. First embodiment
3-2. Second embodiment
3-3. Third embodiment
3-4. Fourth embodiment
3-5. Fifth embodiment
4. Conclusion

### 1. Overview of Matching System According to Embodiment of Present Disclosure

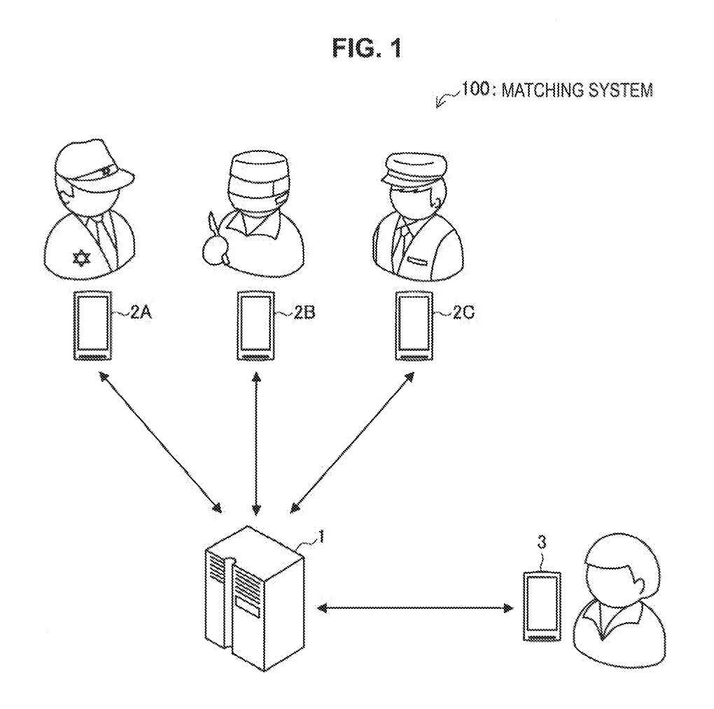

First, with reference to FIG. 1, an overview of a matching system 100 according to an embodiment of the present disclosure will be described. As illustrated in FIG. 1, the matching system 100 according to the embodiment matches service providers (corresponding to volunteers in this specification) with users serving as service requesters by using a server 1. The server 1 collects information on volunteers from volunteer terminals 2A to 2C held by the volunteers, and collects information on a user from a user terminal 3 held by the user. Thereby, the server 1 can match the user with the volunteers in real time and introduce a volunteer to the user in a real space.

### Background

Conventionally, systems for providing information beneficial for users (that is, technologies for linking users and information) have been proposed. However, technologies for linking people in a real space have not been adequately developed yet.

For example, when participants help each other in an event such as sports event or music festival in a real space, it is assumed that a person usually obtains information by explaining his/her situation to another person. However, especially in a case of an international competition such as the Olympic Games, many people come to see the games from various countries, and it is assumed that sometimes verbal communication is difficult. In addition to the language barrier, it is assumed that sometimes communication problems occur due to cultural or habitual difference.

In addition, it is also assumed that many volunteers participate in big events such as the Olympic Games. Such volunteers are registered in advance, and they are capable of providing services such as an interpretation, route guide, guard, medical care, transportation, sightseeing place advice, restaurant advice, cultural exchange, and the like. However, even if there are many volunteers in a venue, it is difficult to introduce an appropriate volunteer to a person in need in real time because it is difficult to express “I need help” due to the language barrier, and cultural or habitual difference, or the person in need does not know where the volunteers are.

Accordingly, the present disclosure proposes the matching system capable of introducing a currency requested person to a requester in a real space in real time.

In the matching system 100 illustrated in FIG. 1, the server 1 receives property information (such as properties (characteristics), volunteer available date and time, and volunteer available area) of respective volunteers from the volunteer terminals 2A to 2C, and registers the volunteers. In addition, when the server 1 receives help information from a user currently in need via the user terminal 3 during an event, the server 1 selects a volunteer who are capable of handling the help request on the basis of the help information and the property information. Subsequently, the server 1 provides information on a position of the user or the like to the volunteer, or provides information on a position of the volunteer or the like to the user. Thereby, the server 1 can introduce the volunteer to the user.

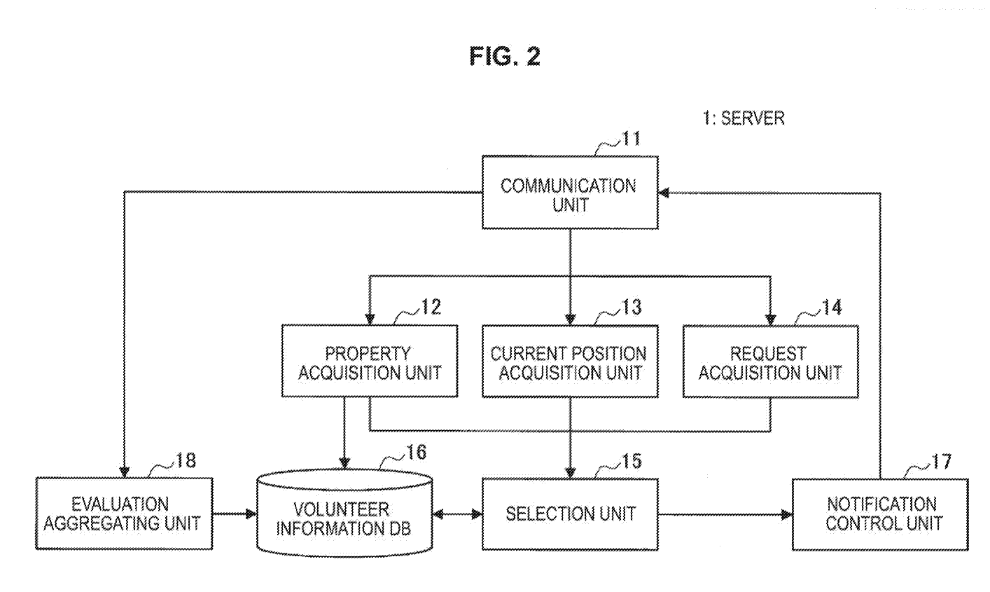

The overview of the matching system 100 according to the embodiment of the present disclosure has been described above. Next, with reference to FIG. 2 to FIG. 4, a basic configuration of the respective device included in the matching system 100 will be described.

### 2. Basic Configuration

### 2-1. Server

FIG. 2 is a block diagram illustrating an example of a configuration of the server 1 according to the embodiment. As illustrated in FIG. 2, the server 1 includes a communication unit 11, a property acquisition unit 12, a current position acquisition unit 13, a request acquisition unit 14, a selection unit 15, a volunteer information DB 16, a notification control unit 17, and an evaluation aggregating unit 18.

The communication unit 11 connects with an external device in a wired/wireless manner, and has a function of transmitting/receiving data. According to the embodiment, the communication unit 11 connects with the volunteer terminals 2A to 2C, receives property information of volunteers, and transmits information on a position or the like of a user who has issued a service request, for example. In addition, the communication unit 11 connects with the user terminal 3, receives help information, position information, and the like from the user, and transmits information on a volunteer who has been selected.

The property acquisition unit 12 acquires information on properties of the volunteers from the information received from the volunteer terminals 2A to 2C via the communication unit 11. The information on the properties of the volunteers includes property types (for example, guard, medical care, transportation, interpretation, and the like), available date and time (for example, weekday/holiday, or morning/noon/night), and coverage areas (for example, region or place) or the like of the volunteers. The property type of the volunteer indicates characteristics of the volunteer (that is, content of available volunteering). The property information transmitted from the volunteer terminals 2A to 2C is assumed to be information input by a person to be registered as the volunteer himself/herself. However, the embodiment is not limited thereto. For example, the property information may be automatically acquired by acquiring characteristics of a target person on the basis of a lifelog, posts on a social network, a purchase history, various types of registration information, or the like of the target person.

The current position acquisition unit 13 acquires information on current positions of the volunteers from the information received from the volunteer terminals 2A to 2C via the communication unit 11. In addition, the current position acquisition unit 13 acquires information on a current position of a user who has issued a help request from the information received from the user terminal 3 via the communication unit 11.

The request acquisition unit 14 acquires content of the request from the help information received from the user terminal 3 via the communication unit 11. The content of the request is information indicating content of the service request. For example, the content of the request includes images capturing the user or surroundings of the user, or text information or audio information for explaining a situation of the user.

The selection unit 15 matches the volunteers providing services with the user who has issued the service request. For example, the selection unit 15 selects a volunteer capable of handling the service request of the user on the basis of the help information acquired by the request acquisition unit 14, with reference to the characteristics, service providable date and time, and current position information of the volunteers. The property information acquired by the property acquisition unit 12 is stored in the volunteer information database (DB) 16. Therefore, the selection unit selects the volunteer with reference to the volunteer information DB 16. In addition, the selection unit 15 may narrows down the selected volunteers to a volunteer currently existing in a predetermined range from the current position of the user, with reference to the current position information of the user.

The volunteer information DB 16 is a storage unit configured to store property information of the volunteers acquired by the property acquisition unit 12.

The notification control unit 17 performs control such that the communication unit 11 issues notification to the volunteer or the user on the basis of a result of the selection performed by the selection unit 15. For example, the notification control unit 17 notifies the volunteer selected by the selection unit 15 of the current position, the help information (status information), and the like of the user who has issued the service request. In addition, the notification control unit 17 notifies the user who has issued the service request of the current position, property information, and the like of the volunteer selected by the selection unit 15.

The evaluation aggregating unit 18 acquires the user's evaluation of the matched volunteer from the user terminal 3 via the communication unit 11, and aggregates the evaluation. Evaluation of each volunteer is stored in the volunteer information DB 16. The evaluation aggregating unit 18 is also capable of ranking the volunteers on the basis of scores and the number of evaluations.

The configuration of the server 1 according to the embodiment has been described above. The configuration of the server 1 illustrated in FIG. 2 is a mere example. The server 1 without the evaluation aggregating unit 18 is also possible. In addition, although the volunteer information DB 16 is an internal memory in the server 1 in the example illustrated in FIG. 2, the embodiment is not limited thereto. The volunteer information DB 16 may be stored in an external memory.

In the server 1, a microcontroller including a central processing unit (CPU), a read only memory (ROM), a random access memory (RAM), and a non-volatile memory is embedded. The microcontroller controls the respective structural elements of the server 1.

### 2-2. Volunteer Terminal

Next, a configuration of the volunteer terminal 2 will be described. In addition to the smartphone illustrated in FIG. 1, the volunteer terminal 2 may be implemented by a tablet terminal, a mobile phone, a personal digital assistant (PDA), various wearable devices (head mounted display (HIVID), smartglasses, smartwatch, smart band, and the like), portable music player, handheld game console, or the like.

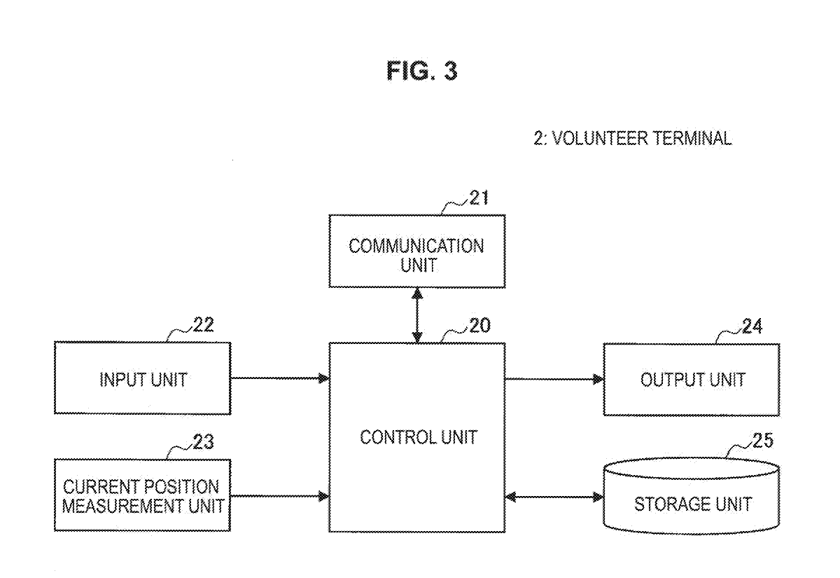

FIG. 3 is a block diagram illustrating an example of the configuration of the volunteer terminal 2 according to the embodiment. As illustrated in FIG. 3, the volunteer terminal 2 includes a control unit 20, a communication unit 21, an input unit 22, a current position measurement unit 23, an output unit 24, and a storage unit 25.

### (Control Unit 20)

The control unit 20 is constituted by a microcontroller including a CPU, a ROM, a RAM, a non-volatile memory, and an interface unit, for example. The control unit 20 controls the respective structural elements of the volunteer terminal 2. Specifically, the control unit 20 according to the embodiment performs control such that the property information and the like input via the input unit 22 are transmitted to the server 1 via the communication unit 21. In addition, the control unit 20 performs control such that the property information registered in the server 1 is stored in the storage unit 25 on the basis of the input property information. The property information includes providable services (property type of volunteer), available date and time, and coverage areas, and the like. In addition, the control unit 20 performs control such that current position information measured by the current position measurement unit 23 is transmitted to the server 1 via the communication unit 21. Transmission of the current position information may be continuously controlled while staying in a certain place (such as event venue for volunteering) on a date and time in which a volunteer can do volunteer work.

In addition, the control unit 20 outputs information on the user who has issued the service request via the output unit 24, and notifies the volunteers of the information on the user. The information on the user is received from the server 1 via the communication unit 21. In addition, the control unit 20 may perform control such that properties of a volunteer are disclosed to surroundings via the output unit 24 in accordance with instructions from the server 1 when the volunteer is in the coverage area of volunteering on the date and time in which the volunteer can do volunteer work.

### (Communication Unit 21)

The communication unit 21 connects with an external device in a wired/wireless manner, and has a function of transmitting/receiving data. For example, the communication unit 21 connects with the server 1, and transmits predetermined information under the control of the control unit 20. The communication unit 21 is also capable of perform [symbol] wireless communication with an external device around the volunteer terminal 2 by means of visible light communication, infrared communication, Bluetooth (registered trademark), Wi-Fi (registered trademark), or the like.

### (Input Unit 22)

The input unit 22 detects information input operation performed by an operator, and transmits detected input information to the control unit 20. For example, the input unit 22 may be implemented by a touch screen, a keyboard, a numeric keypad, a button, a switch, or the like. The input unit 22 implemented by a camera enables gesture input. The input unit 22 implemented by a microphone enables sound input. The input unit 22 may be implemented by various types of input devices.

### (Current Position Measurement Unit 23)

The current position measurement unit 23 has a function of detecting a current position of the volunteer terminal 2 on the basis of a signal acquired from an outside. Specifically, for example, the current position measurement unit 23 is implemented by a global positioning system (GPS) unit, receives radio waves from a GPS satellite, detects a position of the volunteer terminal 2, and outputs information on the detected position to the control unit 20. Instead of the GPS, the current position measurement unit 23 may detect a position through Wi-Fi (registered trademark), transmission/reception with a mobile phone, a PHS, a smartphone, or the like, near-field communication, or the like.

### (Output Unit 24)

The output unit 24 has a function of outputting information in accordance with instructions from the control unit 20. For example, the output unit 24 is implemented by a display unit, and displays text, images, and other information on a screen. The output unit 24 may be implemented by a speaker, a vibration unit, an illumination unit, or the like. The output unit 24 may be implemented by various types of output devices.

In addition to the notification of the current position information or the like of the user who has issued the service request to volunteers, it is also assumed that the output unit 24 according to the embodiment notifies surrounding people of property information of the volunteers. In this case, for example, the output unit 24 is implemented by a display attached to a shoulder, arm, chest, or back part of clothing of the volunteer. The display displays property information (for example, guard, emergency medical care, route guide, game guide, or interpretation) of the volunteer, and thereby surrounding people can be notified of what kinds of services are available.

### (Storage Unit 25)

The storage unit 25 stores various types of data. For example, the storage unit 25 stores a program for executing various processes of the control unit 20. In addition, the storage unit 25 according to the embodiment may store the input property information.

The configuration of the volunteer terminal 2 according to the embodiment has been described above. However, the configuration of the volunteer terminal 2 illustrated in FIG. 3 is a mere example. For example, the volunteer terminal 2 may further include an imaging device.

### 2-3. User Terminal

Next, a configuration of the user terminal 3 will be described. In addition to the smartphone illustrated in FIG. 1, the user terminal 3 may be implemented by a tablet terminal, a mobile phone, a PDA, various wearable devices (HMD, smartglasses, smartwatch, smart band, and the like), portable music player, handheld game console, or the like.

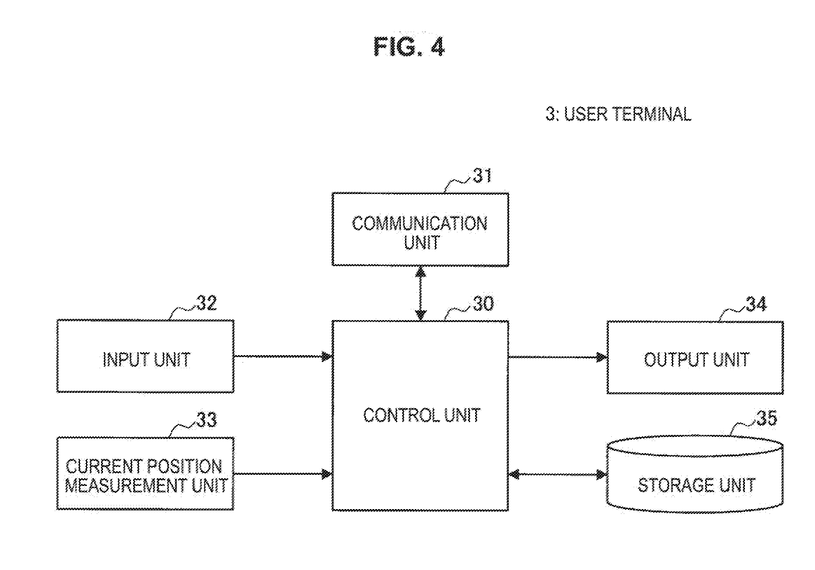

FIG. 4 is a block diagram illustrating an example of a configuration of the user terminal 3 according to the embodiment. As illustrated in FIG. 4, the user terminal 3 includes a control unit 30, a communication unit 31, an input unit 32, a current position measurement unit 33, an output unit 34, and a storage unit 35.

### (Control Unit 30)

The control unit 30 is constituted by a microcontroller including a CPU, a ROM, a RAM, a non-volatile memory, and an interface unit, for example. The control unit 30 controls the respective structural elements of the user terminal 3. Specifically, the control unit 30 according to the embodiment performs control such that the help information and the like input via the input unit 32 are transmitted to the server 1 via the communication unit 21. The help information includes a requested service, a current situation of the user, and the like. In addition, the control unit 30 performs control such that current position information measured by the current position measurement unit 33 is additionally transmitted to the server 1 via the communication unit 31 when transmitting the help information.

In addition, the control unit 30 outputs information on the matched volunteer via the output unit 34, and notifies the user of the information on the matched volunteer. The information on the matched volunteer is received from the server 1 via the communication unit 31.

### (Communication Unit 31)

The communication unit 31 connects with an external device in a wired/wireless manner, and has a function of transmitting/receiving data. For example, the communication unit 31 connects with the server 1, and transmits predetermined information under the control of the control unit 30. The communication unit 31 is also capable of perform wireless communication with an external device around the user terminal 3 by means of visible light communication, infrared communication, Bluetooth (registered trademark), Wi-Fi (registered trademark), or the like.

### (Input Unit 32)

The input unit 32 detects information input operation performed by an operator, and transmits detected input information to the control unit 30. For example, the input unit 32 may be implemented by a touch screen, a keyboard, a numeric keypad, a button, a switch, or the like. The input unit 32 implemented by a camera enables gesture input. The input unit 32 implemented by a microphone enables sound input. The input unit 32 may be implemented by various types of input devices.

### (Current Position Measurement Unit 33)

The current position measurement unit 33 has a function of detecting a current position of the user terminal 3 on the basis of a signal acquired from an outside. Specifically, for example, the current position measurement unit 33 is implemented by a GPS unit, receives signals from a GPS satellite, detects a position of the user terminal 3, and outputs information on the detected position to the control unit 30. The current position measurement unit 33 may detect a position through Wi-Fi (registered trademark), transmission/reception with a mobile phone, a PHS, a smartphone, or the like, near-field communication, or the like.

### (Output Unit 34)

The output unit 34 has a function of outputting information in accordance with instructions from the control unit 30. For example, the output unit 34 is implemented by a display unit, and displays text, images, and other information on a screen. The output unit 34 may be implemented by a speaker, a vibration unit, an illumination unit, or the like. The output unit 34 may be implemented by various types of output devices.

In addition to the notification of the current position information or the like of the matched volunteer, it is also possible for the output unit 34 according to the embodiment to notify the user of volunteers around the user and property information of the volunteers through augmented reality (AR) display.

### (Storage Unit 35)

The storage unit 35 stores various types of data. For example, the storage unit 35 stores a program for executing various processes of the control unit 30.

The configuration of the user terminal 3 according to the embodiment has been described above. However, the configuration of the user terminal 3 illustrated in FIG. 4 is a mere example. For example, the user terminal 3 may further include an imaging device.

### 3. Embodiments

Next, details of the matching system 100 according to the present disclosure will be described with reference to various embodiments.

### 3-1. First Embodiment

First, as a first embodiment of the matching system 100, a case where the server 1 matches volunteers with a user (selects volunteer) and notifies a matched volunteer of current position information of the user, content of a request, and the like when the user issues a help request will be described. This enables an appropriate volunteer to go to the user's location and handle the request even when the user cannot move, for example.

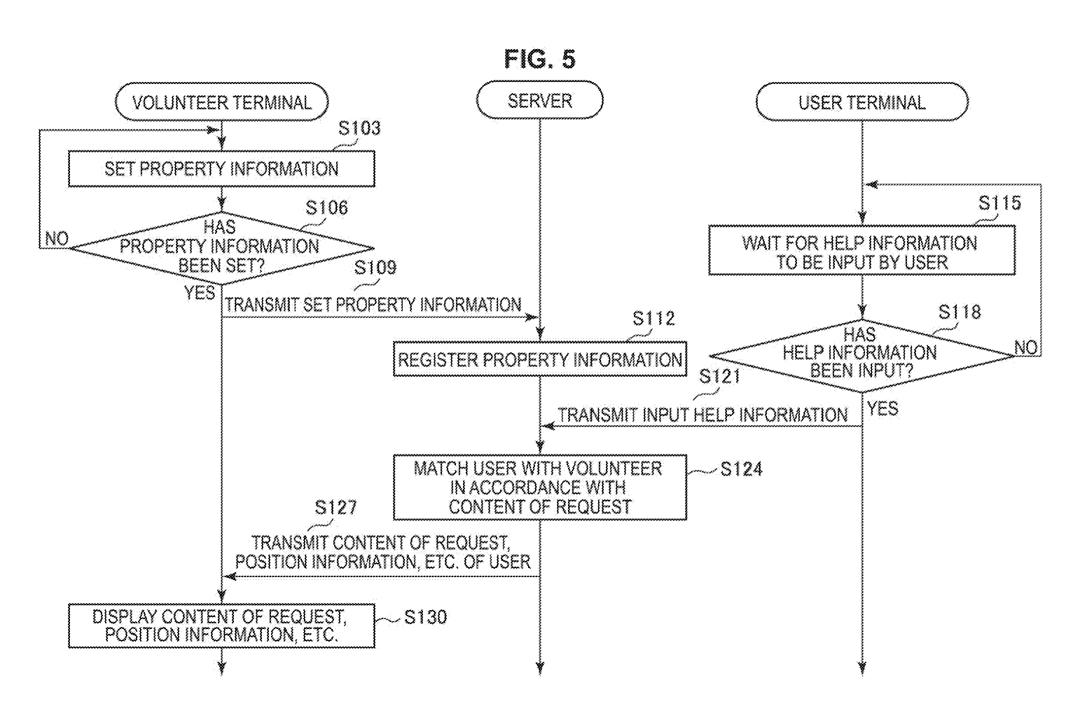

FIG. 5 is a sequence diagram illustrating an operation process according to the first embodiment. As illustrated in FIG. 5, first, in Step S103, the volunteer terminal 2 sets property information of a volunteer on the basis of input information. Specifically, the control unit 20 of the volunteer terminal 2 displays a property information input screen on the display screen or the like, and sets available property types (that is, content of volunteering), types of events that the volunteer desires to participate in, available time slot (weekday/holiday, morning/noon/ evening, and the like), coverage areas (place or region) and the like on the basis of the information input via the input screen. For example, property types of volunteers in an international sports event such as the Olympic Games include the following.

TABLE 1

| Property type | Content |
|---|---|
| Communication | Various types of information are provided for audience |
| | such as location of sports stadium, game start time, and |
| | the like |
| Environment | Venue management and advice such as environmental |
| | protection, way of recycling, and the like |
| Language | Any kind of interpretation for audience |
| Medical care | Emergency medical care for audience |
| Transportation | Driving of bus for carrying audience, parking |
| | management, and the like |
| Performance | Performance in opening ceremony, closing ceremony, and |
| | the like |
| Support for mass media | Support for journalists such as television, newspaper, and |
| | the like |
| PR | any kinds of PR such as provision of event information |
| | and the like |
| Guard | Guard over inside and outside of sports stadium |
| Guide for audience | Steering of audience and guide for audience in sports |
| | stadium |
| Travel guide and | Hotel arrangement and entertainment for audience |
| entertainment | |
| Lecture about culture | Guidance about etiquette of queuing, how to use toilet, |
| (manner) | and the like |
| Lost child support | Help to search for lost child |
| Photo service | Press shutter button of camera, share photo spots, help |
| | printing photos, and the like |
| Internet environment support | Provide information on Wi-Fi spots and the like |

Next, in a case where the property information has been set (“YES” in S106), the volunteer terminal 2 transmits the set property information to the server 1 in Step S109.

Subsequently, in Step S112, the server 1 stores and register the property information received from the volunteer terminal 2 in the volunteer information DB 16.

The above described volunteer property is registered before the event starts or by the day of the event. Next, a matching process that is performed on the day of the event will be described.

In Step S115, the user terminal 3 waits for help information to be input by a user. For example, the display unit (example of output unit 34) of the user terminal 3 displays a help information input screen, and the user terminal 3 waits for the help information to be input by the user.

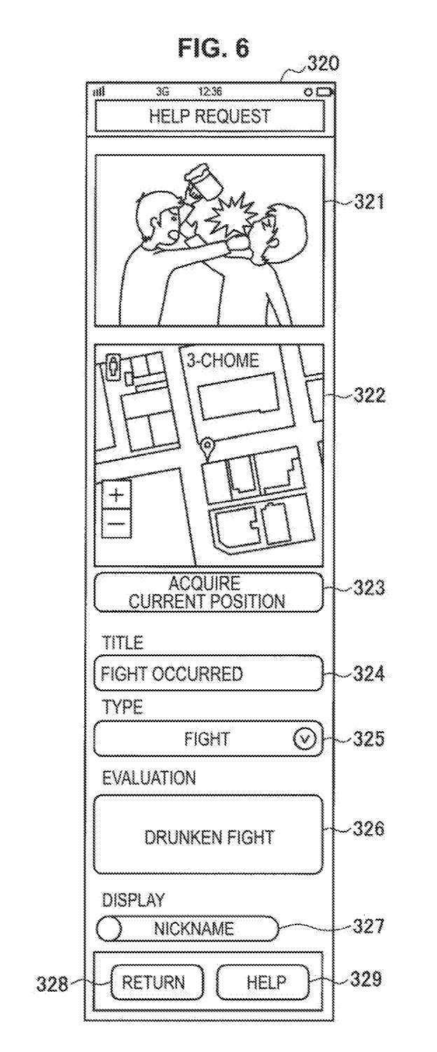

Next, in a case where the help information has been input (“YES” in S118), the user terminal 3 transmits the input help information to the server 1 in Step S121. The help information includes content of the request, current position information of the user terminal 3, and the like. Hereinafter, with reference to FIG. 6, the help information input via the user terminal 3 will be described.

FIG. 6 is a diagram illustrating an example of the help information input screen according to the embodiment. A help information input unit screen 320 illustrated in FIG. 6 is displayed on the display unit of the user terminal 3 in a scrollable manner, for example. As illustrated in FIG. 6, the help information input unit screen 320 includes a captured image (still image/moving image) 321 for explaining a situation, a map image 322 for indicating a current position, a current position acquisition button 323 for acquiring the current position, a summary/title input box 324, a type selector 325 indicating a type of necessary help (requested service), an input box 326 in which details of the situation is input, a nickname display ON/OFF bar 327, a return button 328, and a help button 329.

The captured image 321 for explaining a situation is an image of the appearance of a user himself/herself captured by the imaging unit of the user terminal 3, or an image capturing an on-site situation. When the current position acquisition button 323 is tapped, a current position measured by the current position measurement unit 33 is mapped on a map, and the map image 322 is displayed.

In the summary/title input box 324, the summary or the tile of the content of the request is input. By using the type selector 325, a type of necessary help (requested service) such as fight, disease, lost child, interpretation, or guard is selected. Details of the situation are input to the input box 326. When the help button 329 is tapped, the input content is transmitted to the server 1 as input information.

Next, in Step S124, the selection unit 15 of the server 1 refers to the volunteer information DB 16 and selects a volunteer (matches user with volunteers) in accordance with the content of the request acquired by the request acquisition unit 14. For example, in a case where a medical care service is requested, the selection unit 15 selects volunteers whose property is “medical care”. In addition, the selection unit 15 compares service providable date/time and service providable areas of the volunteers with current date/time and a current position of the user, and selects a volunteer capable of currently going to the user's location.

Next, in Step S127, the server 1 transmits the content of the request, position information, and the like of the user to the volunteer terminal 2 of the selected volunteer.

Subsequently, in Step S130, the volunteer terminal 2 displays the content of the request, the position information, and the like on the display unit (example of output unit 24). Thereby, the volunteer can recognize, in real time, a current position of the user in need with regard to a manner the volunteer can handle, and can go to the user's location in a short time.

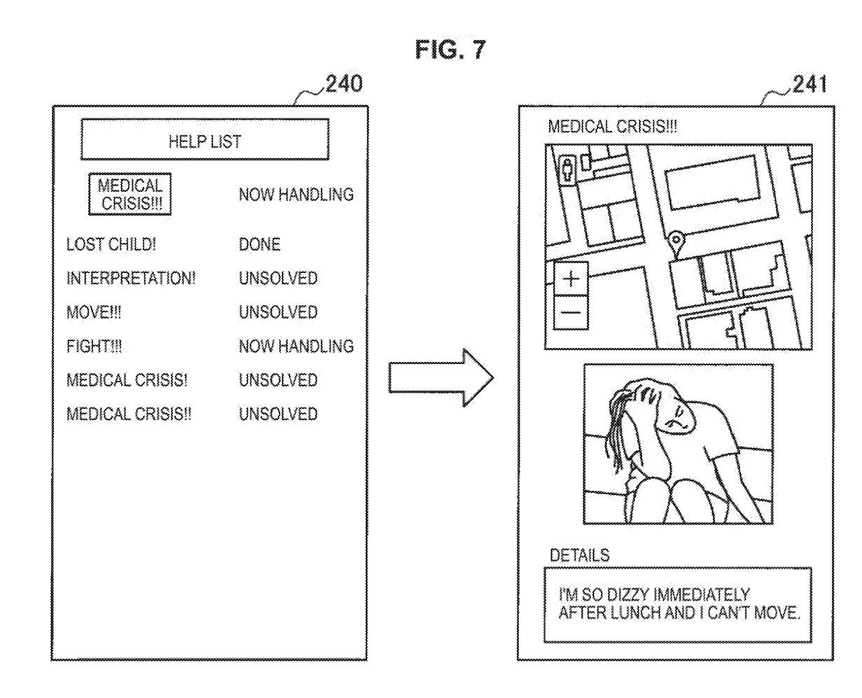

Hereinafter, with reference to FIG. 7, the content of the request, the position information, and the like of the user that are displayed in the volunteer terminal 2 will be described. FIG. 7 is a diagram illustrating an example of a help display screen for volunteers according to the embodiment.

As illustrated in FIG. 7, respective screens are displayed in a scrollable manner on the display unit of the volunteer terminal 2, for example. First, in a case where the server 1 transmits a plurality of pieces of help information as illustrated in the left of FIG. 7, a help information list screen 240 is displayed. For example, the respective pieces of help information to be displayed in the help information list screen 240 may be displayed in chronological order and in the order in which helps are generated. As illustrated in FIG. 7, the help information list screen 240 displays summaries/titles or types of the respective help information pieces, exclamation marks that indicate degrees of urgency of content of help, and current statuses (now handling, done, and unsolved). For example, the degree of urgency of content of a help is represented by the number of exclamation marks, and the degree of urgency may be determined in accordance with content of the request when the selection unit 15 of the server 1 performs volunteer matching. For example, the status of “now handling” is displayed for a help another volunteer has already been handling, the status of “done” is displayed for a help that has already been solved, and the status of “unsolved” is displayed for a help that is unsolved. The user may notify the server 1 whether a volunteer has handled the help, or the volunteer may notify the server 1 whether the volunteer has handled the help.

For example, when “medical crisis! ! !” in the first line is tapped in the help information list screen 240, the screen transitions to a help content screen 241 illustrated in the right of FIG. 7. For example, the help content screen 241 includes a summary/title or a type of a help information piece, a map image that indicates a current position of the user, a captured image that explains a situation, details of the situation, and the like. Thereby, volunteers can recognize what kind of trouble the user is in, a situation and a location of the user.

### (Property Information Collection)

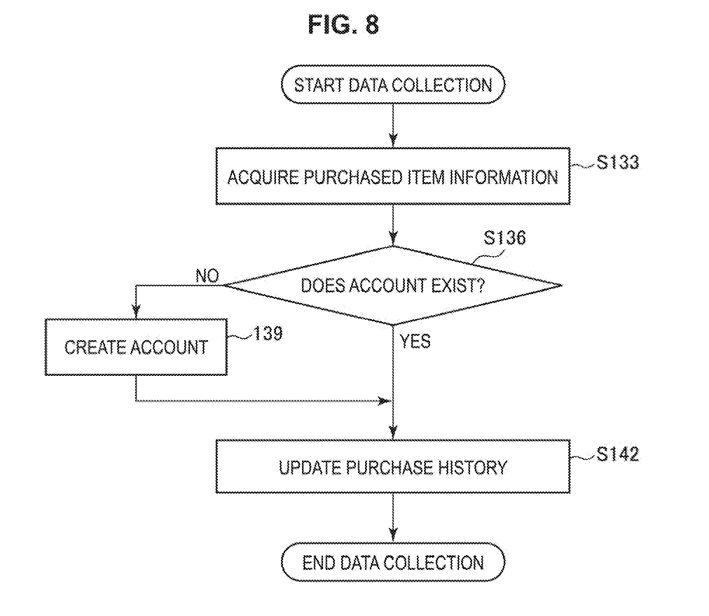

With reference to the sequence diagram illustrated in FIG. 5, a volunteer applicant inputs explicit property information of the volunteer applicant via the volunteer terminal 2. However, the embodiment is not limited thereto. For example, the server 1 may automatically acquire information or property information of a volunteer candidate on the basis of a purchase history, content of posts on social media, event participation information (registration information), behavior information (such as lifelog), images captured by a camera, profession registration information, academic association registration information, web site browsing history, searched keywords, television watch history, recorded TV program information, or the like. Next, with reference to FIG. 8 to FIG. 10, an example of a process of collecting such property information will be described.

FIG. 8 is a flowchart illustrating a process of collecting purchase history data. As illustrated in FIG. 8, first, in Step S133, the server 1 acquires purchased item information from a specific server.

Next, in Step S136, the server 1 determines whether or not an account of an item purchaser has already been created.

Subsequently, in a case where the account does not exist (“NO” in S136), the server 1 creates a new account in Step S139. Here, for example, it is assumed that the server 1 includes a volunteer candidate information DB (not illustrated) and accumulates information on a volunteer candidate. The account to be created corresponds to an account of the volunteer candidate.

Next, in Step S142, the server 1 updates the purchase history in the volunteer candidate information DB in association with the account of the item purchaser.

By accumulating the purchase history of the volunteer candidate in such a way, it is possible to recognize hobbies and preference of the volunteer candidate on the basis of purchased items. For example, in a case where a tennis racket or tennis shoes have been purchased, it is recognized that the purchaser is interested in tennis. In a case where a golf club or golf shoes have been purchased, it is recognized that the purchaser is interested in golf. In addition, it is possible to recognize a device held by the volunteer candidate on the basis of the purchased items. For example, it is possible to recognize that the volunteer candidate holds a camera, smartphone, or a wearable device (smartwatch, smart band, smartglasses, or the like).

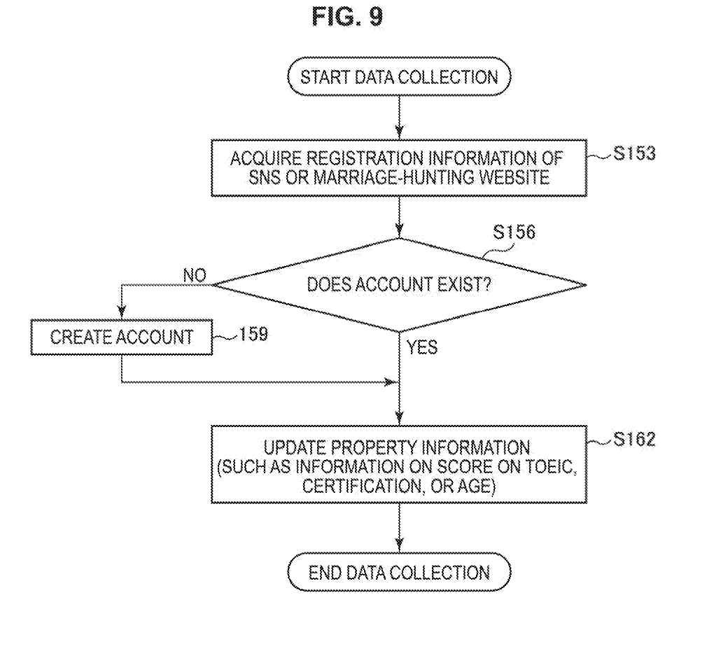

FIG. 9 is a flowchart illustrating a process of collecting information on an SNS or a marriage-hunting website. As illustrated in FIG. 9, first, in Step S153, the server 1 acquires registration information of a social networking service (SNS) or a marriage-hunting website from a specific server.

Next, in Step S156, the server 1 determines whether or not an account of a registrant has already been created.

Subsequently, in a case where the account does not exist (“NO” in S156), the server 1 creates a new account in Step S159.

Next, in Step S162, the server 1 updates the property information in the volunteer candidate information DB in association with the account of the registrant. For example, the registration information includes information on a score on TOEIC, certification earned by the registrant, skills, sex, age, nationality, address, or the like. Such information is used for estimating what kind of volunteer work the registrant can do. Here, the registration information in the marriage-hunting website has been used as an example. However, the embodiment is not limited thereto. It is possible to update property information on the basis of registration information of various events or activities. For example, in a case where the registrant has participated in an event to communicate in French, property information is updated to include a characteristic indicating that the registrant speaks French.

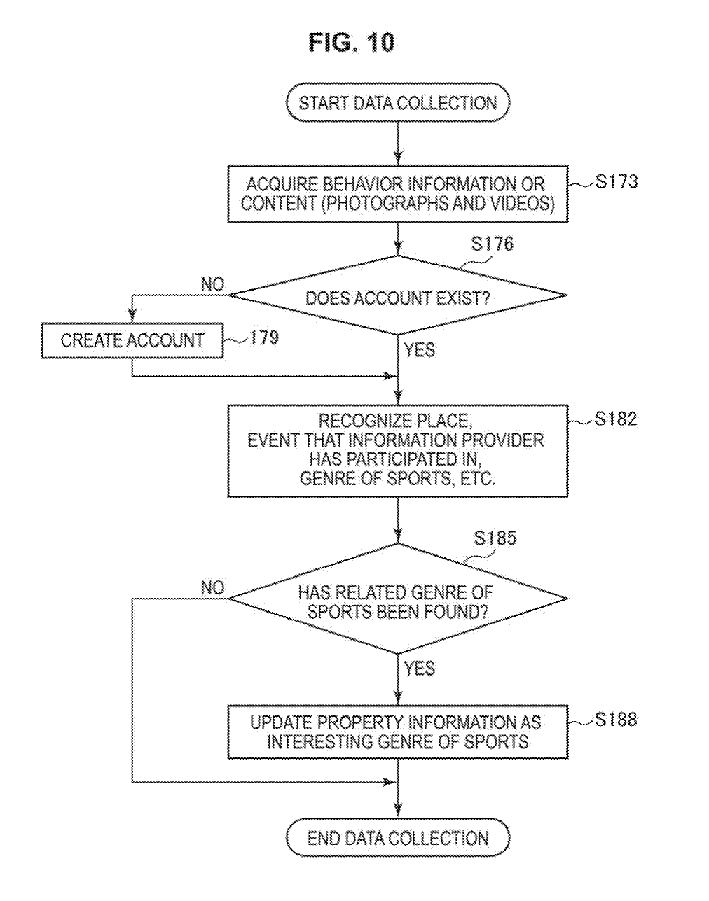

FIG. 10 is a flowchart illustrating a process of collecting behavior information or content (photographs and videos). As illustrated in FIG. 10, first, in Step S173, the server 1 acquires behavior information or content (photographs and videos) from a specific server. The behavior information is movement information based on position information such as the GPS. In addition, the content is photographs or videos captured by a camera or a smartphone. The behavior information may be position information acquired by the GPS equipped in the camera or the smartphone.

Next, in Step S176, the server 1 determines whether or not an account of an information provider has already been created.

Subsequently, in a case where the account does not exist (“NO” in S176), the server 1 creates a new account in Step S179.

Next, in Step S182, the server 1 recognizes a place where the information provider has visited (such as ski resort, tennis court, or sports stadium) or an event that the information provider has participated in (such as marathon event or amateur baseball game) on the basis of the position information, and recognizes a genre of sports that the information provider has watched or played on the basis of the photographs or the videos.

Next, in Step S185, the server 1 searches for a genre of sports related to the place to which the information provider has gone, the event the information provider has participated in, the genre of sports that the information provider has watched, for example.

Subsequently, in a case where the related genre of sports has been found (“YES” in S185), the server 1 updates the property information as the interesting genre of sports in the volunteer candidate information DB in Step S188.

In addition to the above described information collection, the server 1 may acquire information on past volunteer activities from a specific server to update the property information, for example.

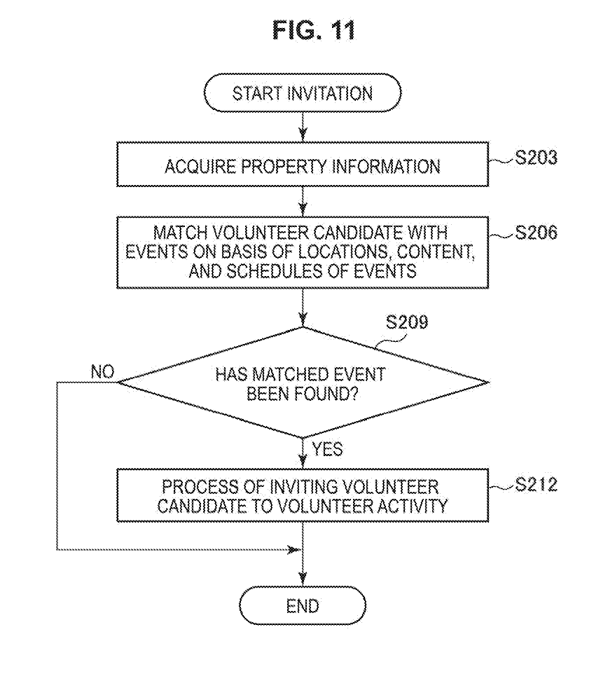

It is also possible for the server 1 to invite volunteers on the basis of the volunteer candidate information DB that is continuously updated on the basis of the collecting information. Next, the following description is given with reference to FIG. 11.

FIG. 11 is a flowchart illustrating a process of inviting a volunteer. As illustrated in FIG. 11, first, in Step S203, the server 1 acquires property information of volunteer candidates accumulated in the volunteer candidate information DB.

Next, in Step S206, the server 1 matches the volunteer candidates with events on the basis of locations, content, and schedules of the events. For example, the server 1 matches a volunteer candidate with a sports event that the volunteer candidate may be interested in, an event held near a place where the volunteer candidate lives, an event that the volunteer candidate may be interested in, or an event that satisfies conditions of skills or the like (capable of speaking French, capable of speaking Chinese, having experience as interpreter, having medical care knowledge, having experience as guard, or the like).

Subsequently, in a case where a matched event has been found (“YES” in S209), the server 1 performs a process of inviting the volunteer candidate to a volunteer activity of the matched event in Step S212. For example, the server 1 performs a process of transmitting an e-mail, a message, or the like to the volunteer candidate to invite the volunteer candidate to the volunteer activity.

### 3-2. Second Embodiment

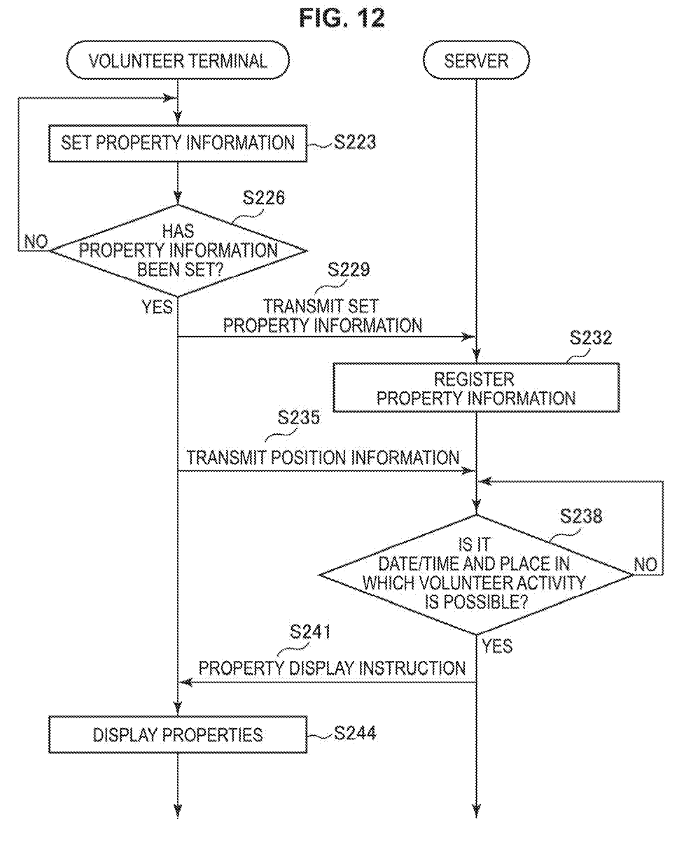

Next, the matching system 100 according to a second embodiment will be described. According to the first embodiment described with reference to FIG. 5, the volunteer terminal 2 displays help information of the user and a volunteer goes to the user's location. However, the embodiment is not limited thereto. For example, a user in need of help can make contact with volunteers by himself/herself if people around volunteers are notified of properties of the volunteers. Hereinafter, with reference to FIG. 12, an operation process of a matching system for issuing a notification of properties of a volunteer to people around the volunteer will be described.

FIG. 12 is a sequence diagram illustrating an operation process according to the second embodiment. As illustrated in FIG. 12, first, in Step S223, the volunteer terminal 2 sets property information of a volunteer on the basis of input information.

Next, in a case where the property information has been set (“YES” in S226), the volunteer terminal 2 transmits the set property information to the server 1 in Step S229.

Subsequently, in Step S232, the server 1 stores and register the property information received from the volunteer terminal 2 in the volunteer information DB 16.

The above described volunteer property is registered before the event starts or by the day of the event. Next, a process that is performed on the day of the event will be described.

In Step S235, the volunteer terminal 2 transmits current position information of the volunteer terminal 2 measured by the current position measurement unit 23, to the server 1. The current position information may be controlled to be continuously transmitted to the server 1 during an event in which the volunteer candidate is registered in advance as a volunteer, or while the volunteer candidates is in the venue of the event in which the volunteer candidate is registered as a volunteer (that can be detected from position information). In a case where the volunteer terminal 2 is a device lent in the venue of the event, it is also possible that the position information is continuously transmitted to the server 1 after the volunteer terminal 2 is powered on.

Next, in Step S238, the selection unit 15 of the server 1 refers to the volunteer information DB 16 and determines whether or not it is date/time and place in which volunteer activity is possible (for example, in venue of event or preset area in a case of vast event venue), on the basis of current time and a current position of the volunteer terminal 2.

Next, in a case where it is the date/time and place in which volunteer activity is possible (“YES” in S238), the server 1 transmits a property display instruction to the volunteer terminal 2 in Step S241.

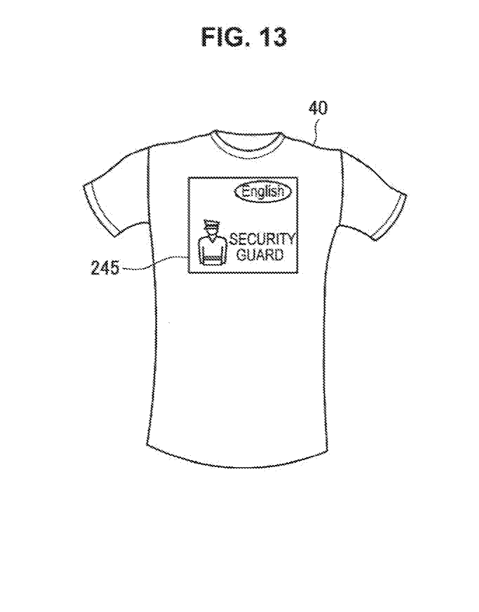

Subsequently, in Step S244, the volunteer terminal 2 displays the properties in response to the instruction from the server 1 to disclose the property of the volunteer himself/herself to people around the volunteer. Next, with reference to FIG. 13, an example of displaying properties of a volunteer will be described.

FIG. 13 is a diagram illustrating an example of displaying properties according to the second embodiment. For example, as illustrated in FIG. 13, properties are displayed on a display 245 (example of output unit 24) attached to clothing 40 worn by a volunteer. Thereby, people around the volunteer can intuitively recognize what kind of work the volunteer can do. In the example illustrated in FIG. 13, the term “English” is displayed at the upper right side for indicating a language that the volunteer can speak, like foreign language badges. In addition, the display “SECURITY GUARD” indicating what kind of volunteer work the volunteer do (role) is displayed. In the example illustrated in FIG. 13, the display indicating what kind of volunteer work the volunteer do (role) is displayed in the language that the volunteer can speak. Thereby, for example, it is possible for participants in the Olympic Games from English-speaking countries to immediately recognize what kind of volunteer work the volunteers do. In addition, such properties are automatically displayed on a date and time on which a previously registered event is held or in a case where the volunteer is in the event venue. This can save the trouble of changing into a volunteer uniform or wearing an armband or the like. In addition, the server 1 can recognize how many volunteers are in which area.

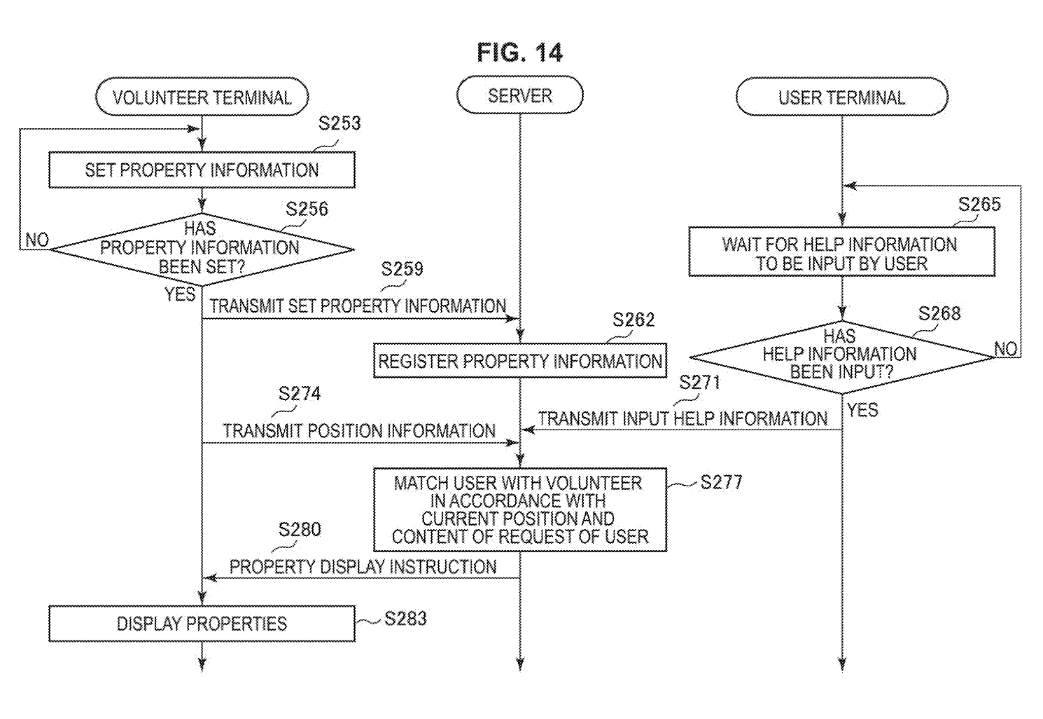

Next, with reference to FIG. 14, a case where the property display is output in accordance with each user issuing help information will be described.

FIG. 14 is a sequence diagram illustrating another operation process according to the second embodiment. As illustrated in FIG. 14, first, in Step S253, the volunteer terminal 2 sets property information of a volunteer on the basis of input information.

Next, in a case where the property information has been set (“YES” in S256), the volunteer terminal 2 transmits the set property information to the server 1 in Step S259.

Subsequently, in Step S262, the server 1 stores and register the property information received from the volunteer terminal 2 in the volunteer information DB 16.

The above described volunteer property is registered before the event starts or by the day of the event. Next, a process that is performed on the day of the event will be described.

In Step S265, the user terminal 3 waits for help information to be input by a user. For example, the display unit (example of output unit 34) of the user terminal 3 displays a help information input screen, and the user terminal 3 waits for the help information to be input by the user.

Next, in a case where the help information has been input (“YES” in S268), the user terminal 3 transmits the input help information to the server 1 in Step S271. The help information includes the content of the request (such as designation of requested service or situation information), current position information of the user terminal 3, and the like.

On the other hand, In Step S274, the volunteer terminal 2 transmits current position information of the volunteer terminal 2 measured by the current position measurement unit 23, to the server 1.

Next, in Step S277, the selection unit 15 of the server 1 matches the user with volunteers in accordance with the current position and the content of the request of the user. Specifically, for example, the selection unit 15 selects a volunteer capable of handling the content of the request of the user from among volunteers around the user or volunteers moving toward the user's location.

Next, in Step S280, the server 1 transmits a property display instruction to the volunteer terminal 2 of the selected volunteer.

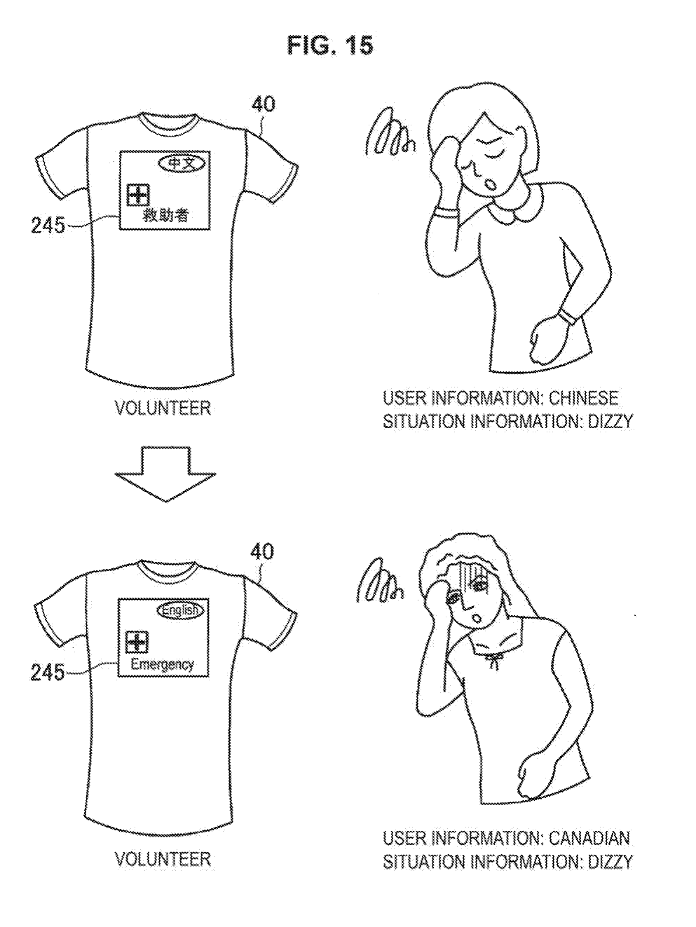

Subsequently, in Step S283, the volunteer terminal 2 displays the properties in response to the instruction from the server 1 to disclose the properties of the volunteer himself/herself to the user. Next, with reference to FIG. 15, an example of displaying properties will be described.

FIG. 15 is a diagram illustrating another example of displaying properties according to the second embodiment. The property display example illustrated in FIG. 15 is similar to the case that has been described with reference to FIG. 13. For example, properties are displayed on the display 245 (example of output unit 24) attached to the clothing 40 worn by a volunteer. Thereby, the user can intuitively recognize what kind of work the volunteer can do. In the example illustrated in FIG. 15, properties are displayed in Chinese as illustrated in the upper side of FIG. 15 in a case where the user is Chinese. In a case where the user is Canadian, properties are displayed in English as illustrated in the lower side of FIG. 15. As described above, properties are displayed in a language depending on a user. For example, the help information transmitted from the user terminal 3 in Step S271 includes information on a language, a country where the user is from, and the like as information on the user. The selection unit 15 of the server 1 selects a volunteer who is capable of handling the content of the request of the user and who can communicate with the user in the language used by the user. Subsequently, the server 1 issues the property display instruction corresponding to the language used by the user, to the volunteer terminal 2.

In this way, according to the embodiment, it is possible to display properties of volunteers in a language used by a user who has issued help information.

### 3-3. Third Embodiment

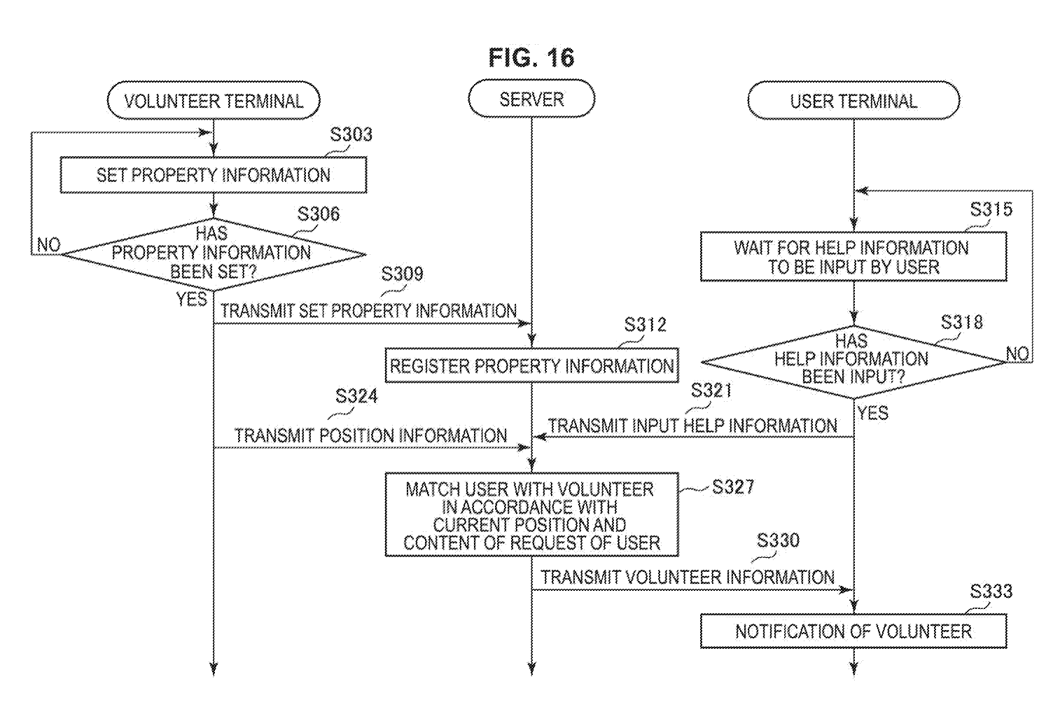

Next, the matching system 100 according to a third embodiment will be described. According to the first and second embodiments described above, volunteers are notified of help information of a user, or volunteers notify people around the volunteers of properties of the volunteers. However, the present disclosure is not limited thereto. For example, a user may be notified of information on a volunteer. Hereinafter, detailed description is provided with reference to FIG. 16.

FIG. 16 is a sequence diagram illustrating an operation process according to the third embodiment. As illustrated in FIG. 16, first, in Step S303, the volunteer terminal 2 sets property information of a volunteer on the basis of input information.

Next, in a case where the property information has been set (“YES” in S306), the volunteer terminal 2 transmits the set property information to the server 1 in Step S309.

Subsequently, in Step S312, the server 1 stores and registers the property information received from the volunteer terminal 2 in the volunteer information DB 16.

The above described volunteer property is registered before the event starts or by the day of the event. Next, a process that is performed on the day of the event will be described.

In Step S315, the user terminal 3 waits for help information to be input by a user. For example, the display unit (example of output unit 34) of the user terminal 3 displays a help information input screen, and the user terminal 3 waits for the help information input by the user.

Next, in a case where the help information has been input (“YES” in S318), the user terminal 3 transmits the input help information to the server 1 in Step S321. The help information includes content of the request (such as designation of requested service or situation information) and current position information of the user terminal 3

On the other hand, in Step S324, the volunteer terminal 2 transmits current position information of the volunteer terminal 2 measured by the current position measurement unit 23, to the server 1.

Next, in Step S327, the selection unit 15 of the server 1 matches the user with volunteers in accordance with the current position and the content of the request of the user. Specifically, for example, the selection unit 15 selects a volunteer capable of handling the content of the request of the user from among volunteers around the user or volunteers moving toward the user's location.

Next, in Step S330, the server 1 transmits information on the selected volunteer to the user terminal 3.

Subsequently, in Step S333, the user terminal 3 notifies the user of the information on the volunteer transmitted from the server 1. Specifically, for example, specific information of the selected volunteer (such as properties, sex, age, and face image) and a map image indicating a current position of the volunteer are displayed on the display unit (example of output unit 34) of the user terminal 3. Thereby, the user can identify and make contact with the volunteer by himself/herself.

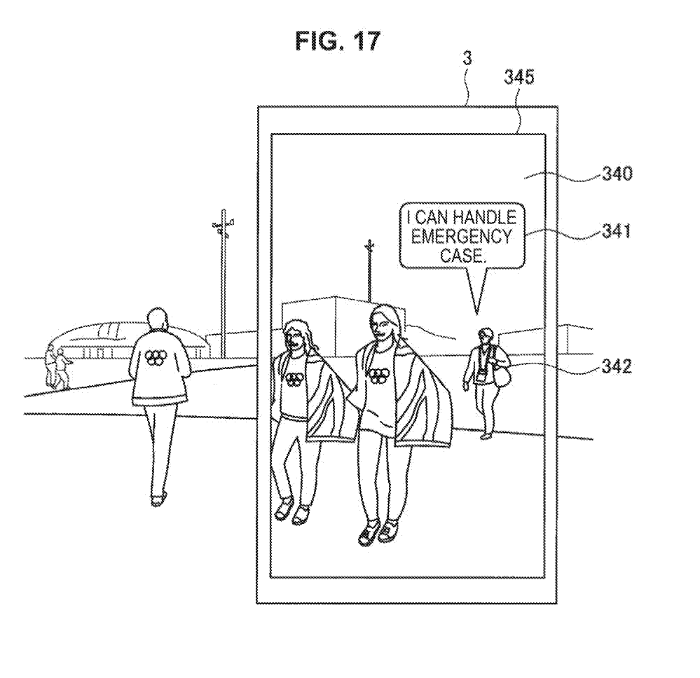

In addition, it is possible to perform AR display of properties of volunteers around a user when holding the user terminal 3 toward surroundings. With reference to FIG. 17, the AR display of volunteer information will be described.

FIG. 17 is a diagram illustrating an example of the AR display of volunteer information according to the third embodiment. As illustrated in FIG. 17, when holding the user terminal 3 toward surroundings, a display unit 345 at a front side of the user terminal 3 displays an image 340 of a real space captured by an imaging unit (not illustrated) at a back side of the user terminal 3. In this case, the control unit 30 of the user terminal 3 analyzes the captured image 340, extract subjects, refers to volunteer information (such as current position information and face image) from the server 1, and recognize the volunteer, for example. In a case where the volunteer recognition has succeeded, as illustrated in FIG. 17, the control unit 30 displays a notification image 341 indicating a property of a volunteer 342 in an overlapped manner on the captured image 340, in association with the volunteer 342 in the captured image 340 displayed on the display unit 345. Thereby, the user can identify and make contact with the volunteer by himself/herself.

### 3-4. Fourth Embodiment

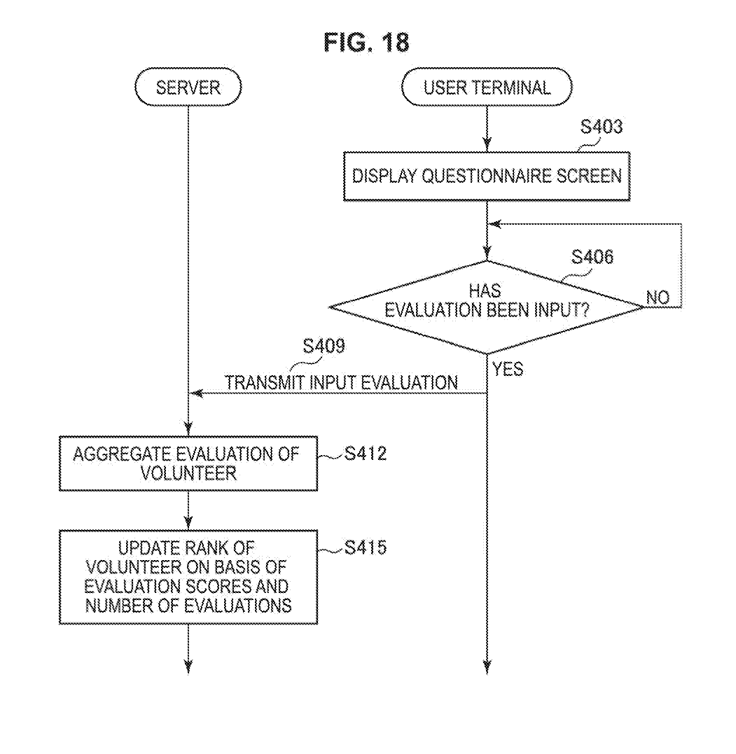

Next, the matching system 100 according to a fourth embodiment will be described. According to this embodiment, a user can evaluate support from a volunteer who has matched with the user, after the support from the volunteer finishes. Thereby, it is possible to feed back the evaluation with regard to the volunteer matching. Hereinafter, the following description is given with reference to FIG. 18.

FIG. 18 is a sequence diagram illustrating an operation process for inputting evaluation according to the fourth embodiment. As illustrated in FIG. 18, first, in Step S403, a questionnaire screen is displayed on the display unit of the user terminal 3, and the user terminal 3 waits for input of evaluation.

Next, in a case where the evaluation has been input (“YES” in Step S406), the user terminal 3 transmits information on the input evaluation to the server 1 in Step S409.

Subsequently, in Step S412, the evaluation aggregating unit 18 of the server 1 aggregates the evaluation of a volunteer received from the user terminal 3 via the communication unit 11. For example, the evaluation aggregating unit 18 calculates an evaluation score on the basis of content of the questionnaire. A result of the evaluation aggregation is stored in the volunteer information DB 16 in association with each volunteer.

Subsequently, in Step S415, the evaluation aggregating unit 18 updates a rank of each volunteer periodically or not periodically on the basis of evaluation scores of each volunteer and the number of evaluations.

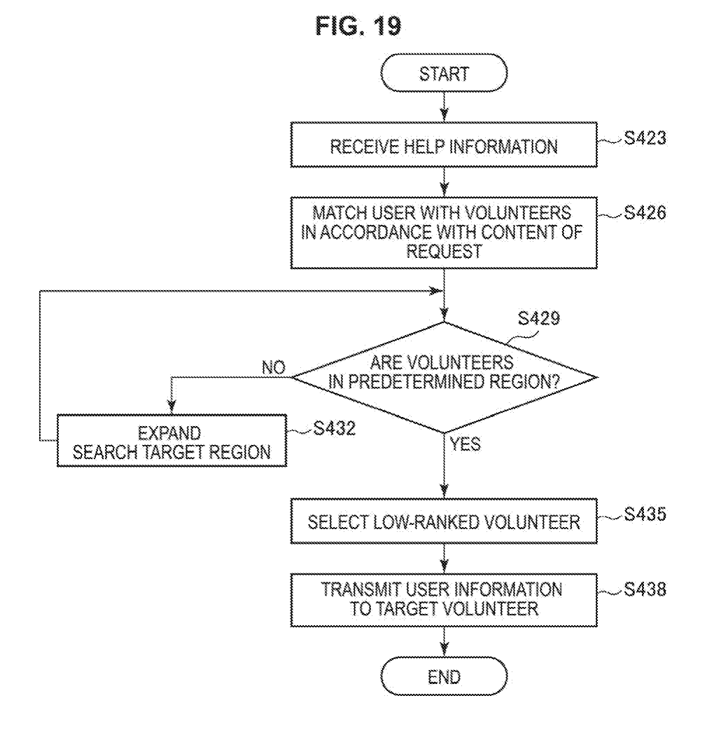

Next, with reference to FIG. 19, matching in view of evaluation of volunteers will be described. FIG. 19 is a flowchart illustrating an operation process of volunteer matching according to the fourth embodiment. As illustrated in FIG. 19, first, in Step S423, the server 1 receives help information from the user terminal 3.

Next, in Step S426, the selection unit 15 of the server 1 refers to the volunteer information DB 16 and selects volunteers (matches user with volunteers) in accordance with content of the request.

Subsequently, in Step S429, the selection unit 15 determines whether or not target volunteers among the selected volunteers are in a predetermined region (area) from a current position of the user. Positions of the target volunteers are determined on the basis of current position information of the volunteer terminals 2 that are continuously transmitted from the volunteer terminals 2.

Next, in a case where no target volunteer is in the predetermined region (“NO” in S429), the selection unit 15 expands the search target region (area) in Step S432. As described above, the selection unit 15 is capable of narrowing down volunteers to all the possible volunteers near the user now.

In a case where the target volunteers are in the predetermined region (“YES” in S429), the selection unit 15 further narrows down the target volunteers to a low-ranked volunteer in Step S435. For example, the selection unit 15 may narrow down the target volunteers to a lowest-ranked volunteer, or may narrow down the target volunteers to volunteers ranked lower than a predetermined value. By narrowing down the volunteers to the low-ranked volunteer, it is possible to avoid concentration of matching on a high-ranked volunteer.

Subsequently, in Step S438, the notification control unit 17 of the server 1 transmits user information to the target volunteer found by narrowing down so as to issue a notification to the target volunteer.

As described above, the server 1 preferentially selects a lowly evaluated volunteer near the user among volunteers capable of providing a service requested by the user. In a case where the user requests an advanced service, the server 1 may perform matching again so as to select a highly evaluated volunteer. The evaluation score and the evaluation rank may be used for giving a title or a prize to a volunteer.

In the matching system described with reference to FIG. 19, a volunteer matched with a user in view of the evaluation rank is notified of the user information. However, the embodiment is not limited thereto. For example, the user may be notified of information on the volunteer matched with the user, or the volunteer matched with the user may be instructed to display his/her properties to people around him/her.

### 3-5. Fifth Embodiment

According to the above described embodiments, the system that matches a user with volunteers in accordance with a help request of the user has been described. However, the matching system according to the present disclosure is not limited thereto. For example, it is also possible to match a volunteer with another volunteer in response to demand from the volunteer in a similar way. In other words, a user according to the above described embodiments may be a volunteer.

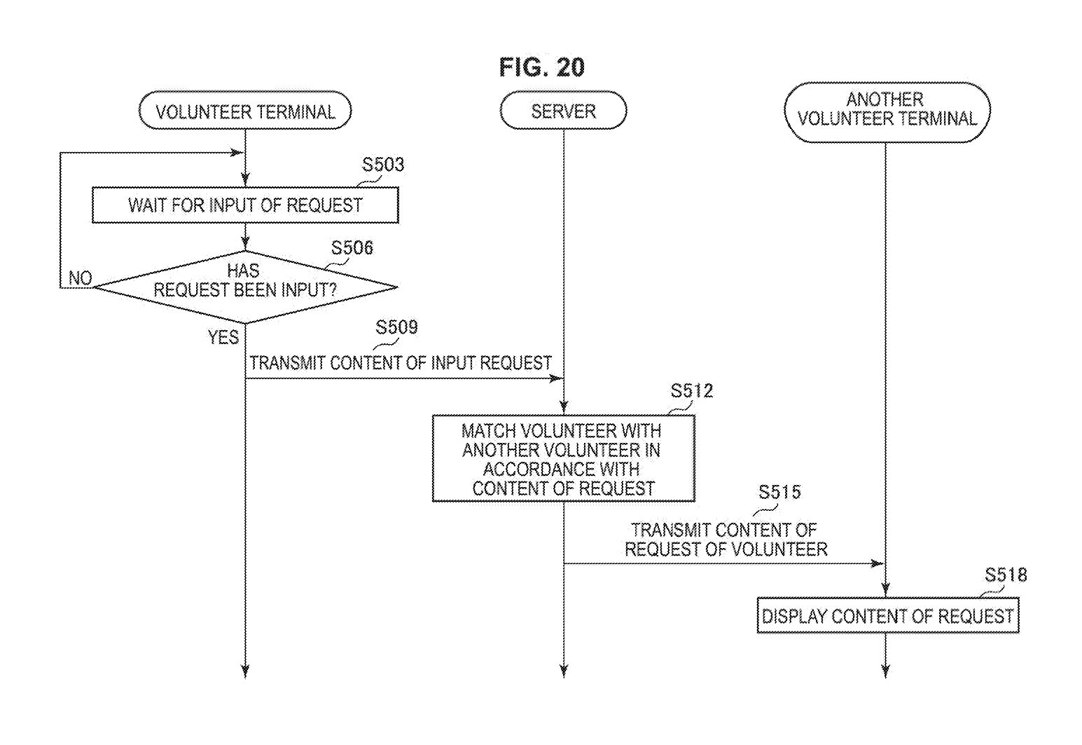

For example, it is assumed that a transportation request is issued to a transportation volunteer to take a user to a hospital after a first-aid action performed by a medical care volunteer, a guard volunteer asks another guard volunteer to come and help him/her, or a guide volunteer asks another guide volunteer with a higher ability value to take a turn. Next, with reference to FIG. 20, such matching between volunteers will be described.

FIG. 20 is a sequence diagram illustrating an operation process of volunteer matching according to a fifth embodiment. As illustrated in FIG. 20, first, in Step S503, the volunteer terminal 2 displays a request input screen on the display unit, and waits for input of a request from a volunteer.

Next, when the request has been input (“YES” in Step S506), the volunteer terminal 2 transmits content of the input request to the server 1 in Step S509. The content of the request includes a types of requested volunteer (medical care, transportation, language, guard, or the like), a reason for the request, a current situation, an image capturing a case now stands, current position information, and the like.

Next, in Step S512, the selection unit 15 of the server 1 refers to the volunteer information DB 16 and matches a volunteer with another volunteer in accordance with the content of request. In this case, the selection unit 15 may select a volunteer with evaluation or a property level higher than the requesting volunteer (such as ability value or proficiency level) in accordance with the reason for the request.

Subsequently, in Step S515, the notification control unit 17 of the server 1 performs control such that the content of request is transmitted to the another volunteer matched with the volunteer.

Next, in Step S518, another volunteer terminal displays the content of request transmitted from the server 1. The content of request includes position information of the volunteer who is the requester.

As described above, according to the embodiment, it is possible to perform matching between volunteers.

### 4. Conclusion

As described above, in the matching system according to the present disclosure, it is possible to introduce a currency requested person to a requester in a real space in real time.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the matching system 100 illustrated in FIG. 1, the server 1 performs the matching process. However, the volunteer terminals 2 may directly communicate with the user terminal 3 as necessary. For example, the volunteer terminal 2 around the user terminal 3 may receive help information sent from the user terminal 3 via infrared communication, Wi-Fi (registered trademark), Bluetooth (registered trademark), or the like, and may notify a volunteer of user information (for example, notification using display or audio). Alternatively, the user terminal 3 may send help information, search for volunteer terminals around the user, and notify the user of existence of volunteers (for example, notification using display or audio). In a case where the user wears a glasses-type wearable terminal for example, AR display of a notification image indicating recognized volunteers may be performed as the notification of existence of the volunteers.

In addition, the user may be registered as a volunteer having a property type same as a volunteer by approval from the volunteer. For example, when getting approval from a volunteer of picking up litter, a user becomes one of the volunteers of picking up litter, gets an evaluation score (point), and becomes capable of passing through a gate of a dump. The approval from the volunteer is transmitted from the volunteer terminal 2 to the server 1 as new volunteer registration information, and stored in the volunteer information DB 16.

In addition, it is also possible for the user terminal 3 to display a map image indicating current positions of volunteers capable of providing a corresponding service when a user selects a requesting service and press the help button.

In addition, it is also possible for the server 1 to continuously monitor current positions of volunteers and prompt volunteers to move to another area in a case where volunteers having a same type of property gather in one area.

In the matching system 100 illustrated in FIG. 1, each of the volunteers and the user has a personal information processing terminal such as a smartphone, and the information processing terminal notifies of information on a partner. However, an information processing device for performing volunteer matching may notifies of information on a partner. The information processing device may be installed in an event space or a place to rest. For example, when a user inputs help information and touch the help button through the help information input screen displayed in the information processing device installed at the event space or the like, a display installed in a volunteer standby space displays the help information and a location (which event space?), and thereby a volunteer can immediately go to the user's location. The volunteer standby spaces may be classified by property types, or may be installed in respective areas.

In addition, the selection unit 15 may refer to the volunteer information DB 16 and preferentially select a volunteer with low property level when performing volunteer matching. This can prevent volunteers with high property level from being matched with easy problems. As described in the fifth embodiment, a volunteer matched with a user asks another volunteer to come and help him/her or to take a turn in a case where the volunteer cannot handle a problem by himself/herself. In this case, the selection unit 15 matches the user with a volunteer with high property level.

It is also possible to create a computer program for causing hardware such as a CPU, a ROM, and a RAM, which are embedded in the server 1, the volunteer terminal 2, or the user terminal 3, to execute the functions of the server 1, the volunteer terminal 2, or the user terminal 3. Moreover, it is possible to provide a computer-readable recording medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

A matching system including:

an acquisition unit configured to acquire information on service providers; and

a selection unit configured to select a service provider capable of handling a service request by reference to service providable time of the service providers, current positions of the service providers, and characteristics of the service providers that are included in the information on the service providers acquired by the acquisition unit.
(2)

The matching system according to (1), further including

a notification unit configured to notify the service provider selected by the selection unit of information on a requester who has issued the service request.
(3)

The matching system according to (2),

wherein the notification unit issues notification of a current position of the requester and request content.
(4)

The matching system according to (2) or (3),

wherein the notification unit displays information indicating that it is possible to handle the service request, on a display device for the requester held by the service provider selected by the selection unit.
(5)

The matching system according to (4),

wherein the display device for the requester is attached to clothing of the service provider.
(6)

The matching system according to (1), further including

a notification unit configured to notify a requester who has issued the service request of information on the service provider selected by the selection unit.
(7)

The matching system according to (6), wherein

the selection unit narrows down the selected service providers to a service provider around the requester, and

the notification unit notifies the requester of which person the service provider found by the selection unit through narrowing down is, among people around the requester.
(8)

The matching system according to (7),

wherein the notification unit displays a notification image indicating which person the service provider is, on a display device held by the requester in an overlapping manner with a real space.
(9)

The matching system according to any one of (1) to (8),

wherein the characteristic of the service provider indicates content of a providable service.
(10)

The matching system according to any one of (1) to (9), further including

an evaluation aggregating unit configured to aggregate evaluation of the service provider performed by a person who has issued the service request.
(11)

The matching system according to (10),

wherein the selection unit narrows down the service providers on the basis of the evaluation aggregated by the evaluation aggregation unit.
(12)

The matching system according to any one of (1) to (11),

wherein, in a case where a requester who has issued the service request requests re-selection, the selection unit narrows down the service providers to a service provider with higher evaluation or with a higher ability value than a service provider that has been selected last time.
(13)

An information processing device including:

an acquisition unit configured to acquire information on service providers; and

a selection unit configured to select a service provider capable of handling a service request by reference to service providable time of the service providers, current positions of the service providers, and characteristics of the service providers that are included in the information on the service providers acquired by the acquisition unit.
(14)

A matching method including:

acquiring information on service providers; and

selecting a service provider capable of handling a service request by reference to service providable time of the service providers, current positions of the service providers, and characteristics of the service providers that are included in the acquired information on the service providers.
(15)

A program causing a computer to function as:

an acquisition unit configured to acquire information on service providers; and

a selection unit configured to select a service provider capable of handling a service request by reference to service providable time of the service providers, current positions of the service providers, and characteristics of the service providers that are included in the information on the service providers acquired by the acquisition unit.

### REFERENCE SIGNS LIST

100 matching system
1 server
11 communication unit
12 property acquisition unit
13 current position acquisition unit
14 request acquisition unit
15 selection unit
16 volunteer information DB
17 notification control unit
18 evaluation aggregating unit
2 (2A to 2C) volunteer terminals
20 control unit
21 communication unit
22 input unit
23 current position measurement unit
24 output unit
25 storage unit
3 user terminal
30 control unit
31 communication unit
32 input unit
33 current position measurement unit
34 output unit
35 storage unit

1. A matching system comprising:
an acquisition unit configured to acquire information on service providers; and
a selection unit configured to select a service provider capable of handling a service request by reference to service providable time of the service providers, current positions of the service providers, and characteristics of the service providers that are included in the information on the service providers acquired by the acquisition unit.

2. The matching system according to claim 1, further comprising
a notification unit configured to notify the service provider selected by the selection unit of information on a requester who has issued the service request.

3. The matching system according to claim 2,
wherein the notification unit issues notification of a current position of the requester and request content.

4. The matching system according to claim 2,
wherein the notification unit displays information indicating that it is possible to handle the service request, on a display device for the requester held by the service provider selected by the selection unit.

5. The matching system according to claim 4,
wherein the display device for the requester is attached to clothing of the service provider.

6. The matching system according to claim 1, further comprising
a notification unit configured to notify a requester who has issued the service request of information on the service provider selected by the selection unit.

7. The matching system according to claim 6, wherein
the selection unit narrows down the selected service providers to a service provider around the requester, and
the notification unit notifies the requester of which person the service provider found by the selection unit through narrowing down is, among people around the requester.

8. The matching system according to claim 7,
wherein the notification unit displays a notification image indicating which person the service provider is, on a display device held by the requester in an overlapping manner with a real space.

9. The matching system according to claim 1,
wherein the characteristic of the service provider indicates content of a providable service.

10. The matching system according to claim 1, further comprising
an evaluation aggregating unit configured to aggregate evaluation of the service provider performed by a person who has issued the service request.

11. The matching system according to claim 10,
wherein the selection unit narrows down the service providers on the basis of the evaluation aggregated by the evaluation aggregation unit.

12. The matching system according to claim 1,
wherein, in a case where a requester who has issued the service request requests re- selection, the selection unit narrows down the service providers to a service provider with higher evaluation or with a higher ability value than a service provider that has been selected last time.

13. An information processing device comprising:
an acquisition unit configured to acquire information on service providers; and
a selection unit configured to select a service provider capable of handling a service request by reference to service providable time of the service providers, current positions of the service providers, and characteristics of the service providers that are included in the information on the service providers acquired by the acquisition unit.

14. A matching method comprising:
acquiring information on service providers; and
selecting a service provider capable of handling a service request by reference to service providable time of the service providers, current positions of the service providers, and characteristics of the service providers that are included in the acquired information on the service providers.

15. A program causing a computer to function as:
an acquisition unit configured to acquire information on service providers; and
a selection unit configured to select a service provider capable of handling a service request by reference to service providable time of the service providers, current positions of the service providers, and characteristics of the service providers that are included in the information on the service providers acquired by the acquisition unit.
